(19) United States
(12) Patent Application Publication
(10) Pub. No.: US 2008/0156274 A1
(43) Pub. Date: Jul. 3, 2008

(54) Timer activated doggie door opener

(76) Inventors: Mary Margaret Andrade, Phoenix, AZ (US); David Charles Andrade, Phoenix, AZ (US)

Correspondence Address: Raymond M. Galasso;Galasso & Associates LP, P.O. Box 26503, Austin, TX, 78755-0503, US

(21) Appl. No.: 11/649,012

(22) Filed: Jan. 3, 2007

(51) Int. Cl. A01K 1/00

(52) U.S. Cl. 119/484; 340/573.3

(57) ABSTRACT

Timer Activated Doggie Door Opener is an automatic pet door that has a timer and motor to allow the door to open at designated times of the day. To use the preferred embodiment of Timer Activated Doggie Door Opener, a user selects a door or exterior wall to install the device and cuts an appropriate sized opening in the wall or door to accommodate the pet door. The user then attaches the frame and tracks of the device to the wall or door. A user then plugs the timer into a standard wall outlet and sets the timer to go on at a selected time. When the appropriate time is reached, power is sent to the motor which begins to reel the wire connected to the pet door into the housing of the motor, causing the pet door to slide along the upper and lower tracks to reveal the opening in the door or wall. When the user decides to close the pet door, he simply applies manual force to the pet door to cause the reeled in wire to unwind from the housing and allow the pet door to again cover the opening in the door or wall.

### CROSS REFERENCE TO RELATED APPLICATIONS

This U.S. Non-Provisional Patent Application does not claim priority to any U.S. Provisional Patent Applications or any foreign patent applications.

### FIELD OF THE DISCLOSURE

The disclosures made herein relate generally to the household pet accessories industry. The invention discussed herein is in the general classification of automatic pet doors.

### BACKGROUND

Many households in the United States have one or more pets. Cats and dogs are among the most popular pets. In the United States, there are an estimated seventy million cats and fifty-five million dogs. Many individuals consider their pets to be members of the family and spend enormous sums of money for healthcare, food, toys, and other pet accessories.

Pet owners constantly are looking for new and innovative ways to keep their pets healthy and happy. Many pet owners like to ensure the comfort of their pets by allowing the animal to live in the home. Household pets are constant companions and are also healthier as they do not have to deal with the extremes of weather or come into contact with disease carrying insects or other wildlife.

Even when a pet spends the majority of each day inside a house, most animals still enjoy going outside for a portion of the day. It is often necessary for pets such as dogs to go outside to relieve themselves or to get adequate exercise. Many pet owners install doggie doors or pet doors to permit their pets to come in and out of the house as desired.

Unfortunately, traditional pet doors allow pets to enter or leave the home even when the owner may not want them to do so. Sometimes pet owners do not want their animals going outside too early in the morning if their barking may disturb neighbors. Pet owners also might want their pets to spend a certain amount of time outside to ensure that they are getting the proper amount of exercise. Other times, pet owners may want their pets to go outside when a friend with allergies visits the home. When a pet owner is home, he can block or grant access to the pet door in these types of situations. However, if a pet owner is away from home running errands or at work, the owner has no way of controlling access to the pet door for a set amount of time.

Hence, there is a need in the art for an easy to use, inexpensive and effective device for automatically opening a pet door for a pet to use during the day.

### SUMMARY OF THE DISCLOSURE

Timer Activated Doggie Door Opener is an automatic pet door that has a timer and motor to allow the pet door to open at designated times of the day.

The principal object of this invention is to provide a timer activated pet door that will allow an owner to control access to the outdoors even when he is not present at the house.

Another object of this invention is to provide an affordable pet door that automatically opens at designated times.

Another object of this invention is to provide a pet door that is easily and quickly installed.

Another object of this invention is to provide a durable pet door that can be set to automatically open at designated times.

Yet another object of this invention is to provide an easy to use automatic pet door.

### BRIEF DESCRIPTION OF THE DRAWINGS

FIG. 1 depicts a perspective view of the preferred embodiment of the invention mounted to a wall with an opening cut in the wall.

### DETAILED DESCRIPTION OF THE DRAWINGS

The preferred embodiment of Timer Activated Doggie Door Opener is comprised of at least some of the following: a frame, a pet door, tracks for the pet door, a timer, and a motor.

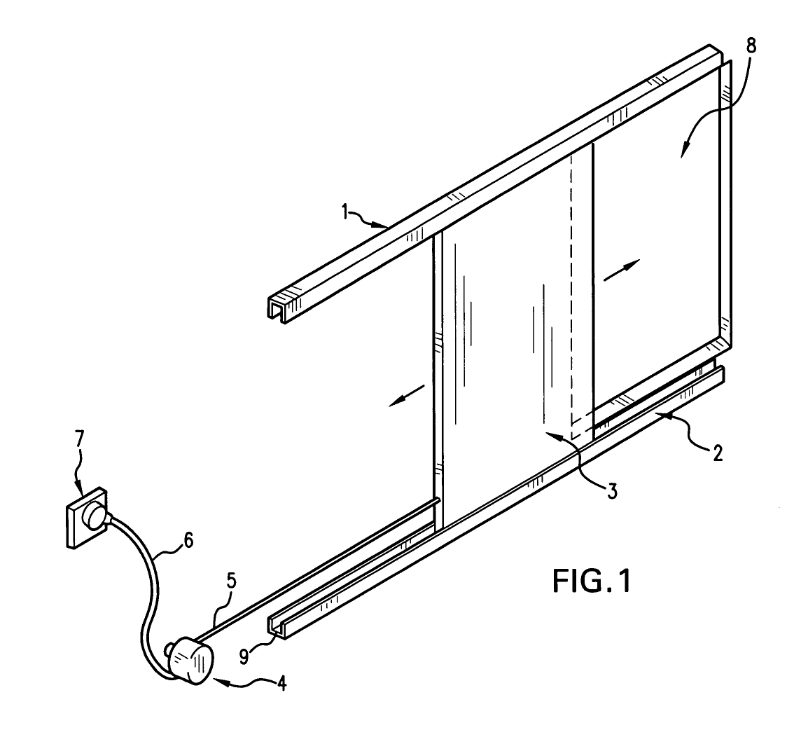

In the preferred embodiment of the invention, shown in FIG. 1, an upper track 1 and a lower track 2 hold a pet door 3. A frame (not pictured) is located on the right side of the upper track 1 and the lower track 2 and connects the upper track 1 and the lower track 2 and also has a channel configured to accept the side of the pet door 3, allowing the pet door 3 to slide all the way to the right to close the opening 8 in a wall. The pet door 3 can also move to the left on the upper track 1 and the lower track 2 to reveal the opening 8 in the wall. A variety of sliding mechanisms can be used to allow the pet door 3 to move more easily in the channels 9 of the upper track 1 and the lower track 2, including wheels or bearing inserts. The pet door 3 is made of plastic and the upper track 1, the lower track 2 and frame are made of metal in this preferred embodiment though other materials may also be utilized. In addition, the upper track 1 and the lower track 2 have holes (not pictured) on the inner side of the tracks that can be utilized for mounting to a wall or door with screws. The pet door 3 is rectangular in shape in this preferred embodiment though other shapes may also be utilized, including square.

The pet door 3 is operatively connected to a motor (not pictured). In this preferred embodiment, a wire 5 attaches to the pet door 3 on one side and enters a housing 4 containing a spool (not pictured) and a motor on the other side. The motor has a cord 6 that connects to a timer 7 that is plugged into the wall. The housing 4 can be anchored to a wall or other appropriate location using brackets or screws. Ideally, the housing containing the motor and spool would be anchored to a wall in the same plane as the door to permit the wire to pull directly on the door rather than at an angle to the door. Other arrangements to operatively attach the motor and door are also possible.

To use the preferred embodiment of Timer Activated Doggie Door Opener, a user selects a door or exterior wall to install the device and cuts an appropriate sized opening in the wall or door to accommodate the pet door. The user then attaches the frame and tracks of the device to the wall or door. A user then plugs the timer into a standard wall outlet and sets the timer to go on at a selected time. When the appropriate time is reached, power is sent to the motor which begins to reel the wire connected to the pet door into the housing of the motor, causing the pet door to slide along the upper and lower tracks to reveal the opening in the door or wall. When the user decides to close the pet door, he simply applies manual force to the pet door to cause the reeled in wire to unwind from the housing and allow the pet door to slide along the tracks and again cover the opening in the door or wall. The presence of a frame on one side will make it more difficult for a pet to slide the door open on his or her own when the pet door is slid to its closed position.

In alternative embodiments, the door could also be set to close automatically. Several embodiments of the invention could also utilize a flip open pet door that attaches to a motor and timer and does not require tracks or a frame. In addition, an alarm could be attached to the device to sound an audible alarm for the pet that the door is open. This alarm could be an invaluable tool in training the pet to know what time of day the door opens and could have a selector switch enabling it to be disabled when the pet has learned when the door will open. A decal may also be put on the pet door to give the pet a visual reminder of when the pet door is open or closed.

The preferred embodiment of the invention would come in different sizes to accommodate different size pets. The frame connected to the tracks of the preferred embodiment could also come on the left or right side to accommodate different living spaces.

The components of Timer Activated Doggie Door Opener may vary but will likely use metal, plastic and electrical materials. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Timer Activated Doggie Door Opener can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the components of the invention can be made of different types of metals, plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A pet device comprising:
(a) a door operatively connected to a motor; and
(b) a timer operatively connected to the motor.

2. The device of claim 1 wherein the door is located between an upper track and a lower track.

3. The device of claim 2 wherein the door has a frame that connects with the upper track and the lower track on one side.

4. The device of claim 2 wherein the upper track and the lower track are mountable to a wall.

5. The device of claim 1 wherein the motor is mountable to a wall.

6. The device of claim 1 wherein the door is made of plastic.

7. The device of claim 1 wherein the door is rectangular.

8. The device of claim 2 wherein the upper track and the lower track are made of metal.

9. The device of claim 3 wherein the frame is made of metal.

10. The device of claim 2 wherein a first channel is located in the upper track and a second channel is located in the lower track.

11. The device of claim 10 wherein a first sliding mechanism is located in the first channel and a second sliding mechanism is located in the second channel.

12. The device of claim 11 wherein the first sliding mechanism is a bearing insert and the second sliding mechanism is a bearing insert.

13. The device of claim 1 wherein the motor is contained within a housing.

14. The device of claim 13 wherein the housing is made of plastic.

15. The device of claim 13 wherein the housing contains a spool with a wire that attaches to the door.

16. The device of claim 1
further comprising an alarm system operatively attached to the timer.

17. The device of claim 1 wherein a selector switch is located on the alarm system.

18. The device of claim 1 wherein a decal is located on the door.

19. A pet device comprising:
(a) a housing containing a motor and a spool with a wire wherein the wire emanates from the housing and connects to a door that is plastic and rectangular and has a decal;
(b) an upper track with a first channel made of metal and a lower track with a second channel made of metal that hold the door within the first channel and the second channel;
(c) a first bearing insert within the first channel and a second bearing insert within the second channel;
(d) a frame made of metal that connects with the upper track and the lower track on one side;
(e) a timer connected to the motor via a cord; and
(f) an alarm system operatively attached to the timer and having a selector switch.
